(19) United States
(12) Patent Application Publication
(10) Pub. No.: US 2021/0075843 A1
(43) Pub. Date: Mar. 11, 2021

(54) Quality Metadata Signaling for Dynamic Adaptive Streaming of Video

(71) Applicant: BITMOVIN, INC., San Francisco, CA (US)

(72) Inventors: Christian FELDMANN, Berlin (DE); Martin SMOLE, Klagenfurt (AT); Christopher MUELLER, Pörtschach (AT); Daniel WEINBERGER, Klagenfurt (AT); Armin TRATTNIG, Klagenfurt (AT)

(73) Assignee: BITMOVIN, INC., San Francisco, CA (US)

(21) Appl. No.: 16/763,199

(22) PCT Filed: Nov. 15, 2018
(86) PCT No.: PCT/US2018/061214

§ 371 Date: May 11, 2020

Related U.S. Application Data
(60) Provisional application No. 62/587,184, filed on Nov. 16, 2017.

(51) Int. Cl. H04L 29/06

(52) U.S. Cl. CPC H04L 65/80; H04L 65/60

(57) ABSTRACT

A video streaming system optimizes the buffering of periods of frames of a video presentation in order to achieve a more constant perceptual quality throughout the entire video presentation. An adaption algorithm determines transmission bitrates to transmit some periods at a lower bitrate that the channel conditions of the channel may allow while transmitting other periods at a higher bitrate. The transmission bitrates are determined based on expected quality metadata signaled in the periods of the bitstream for the current period and following periods in order to optimize the bitrate and the expected perceptual quality of each version of each period over time.

### CROSS-REFERENCE TO RELATED APPLICATIONS

This application claims the benefit of U.S. Provisional Application No. 62/587,184, filed Nov. 16, 2017 and which is incorporated herein by reference in its entirety.

### BACKGROUND OF THE INVENTION

This disclosure generally relates to streaming and playback of video, and more particularly to optimization of video encoding and decoding methods in video encoders and decoders for dynamic adaptive streaming of video.

In addition to the more traditional televisions and projector-based systems connected to Internet-provider networks at the home, many playback devices today are mobile devices, such as tablets, smartphones, laptops, and the like, which are usually connected to a network over an unreliable wireless connection with widely variable network conditions. Transmitting high-quality video over the network poses a great challenge. To cope with this problem, a solution called adaptive bitrate streaming has been used. A video presentation encoded for adaptive streaming is conventionally split into parts. Each part contains a certain number of frames and each part can be decoded independently. Each of these parts (or period of frames) is encoded in several versions where each version uses a different encoding bitrate. Depending on the varying bitrate available during streaming in the transmission channel, an adaption algorithm is used to decide which version of each period of frames should be transmitted and decoded according to variations in channel conditions.

The quality of the video in a period of frames generally increases with an increasing encoding bitrate. However, the reconstruction quality of different periods of frames encoded at the same bitrate is not constant and varies depending on the content of the video encoded within the period frames. In the prior art approach for adaptive streaming, a streaming adaption algorithm optimizes quality by selecting each period at the highest possible bitrate allowed by the cannel conditions. In this case, the perceived quality of the video over time may vary significantly depending on the video content, even when the period of frames are encoded at the same or even higher bitrates. This behavior over time is undesirable.

### SUMMARY OF THE INVENTION

According to various embodiments, a method and system for streaming video presentations is provided. According to one embodiment, a method is provided for optimizing buffering of periods of frames of a streaming video presentation while minimizing variation in perceptual quality of the video presentation. In this embodiment, the method comprises buffering a plurality of periods of frames of a video presentation for transmission in a stream. Each period of frames in the plurality of periods of frames includes a metadata portion with metadata descriptive of an expected visual quality of the period of frames and a set of following periods of frames. The method further comprises analyzing the metadata in a current period of frames to determine a first transmission bitrate for the current period of frames and a second transmission bitrate for a period of frames in the set of following periods of frames. In this embodiment, the first transmission bitrate and the second transmission bitrate are selected to maintain a substantially uniform visual quality based on the expected visual quality.

According to this embodiment, the method also includes transmiting the current period of frames at the first transmission bitrate and transmitting the period of frames in the set of following periods of frames at the second transmission bitrate. In this embodiment, the the first transmission bitrate is different than the second transmission bitrate and at least one of the first transmission bitrate or the second transmission bitrate is lower than a highest bitrate that would be achievable given a current set of channel conditions.

According to another embodiment, a system is provided with a buffer configured to buffer a plurality of periods of frames of a video presentation for transmission in a stream. In this embodiment, each period of frames in the plurality of periods of frames includes a metadata portion with metadata descriptive of an expected visual quality of the period of frames and a set of following periods of frames. The system further includes a processor configured for controlling transmissions out of the buffer and to analyze the metadata in a current period of frames to determine a first transmission bitrate for the current period of frames and a second transmission bitrate for a period of frames in the set of following periods of frames. In this embodiment, the first transmission bitrate and the second transmission bitrate are selected to maintain a substantially uniform visual quality based on the expected visual quality. The system further includes a network interface for streaming the video presentation and that is configured to transmit the current period of frames at the first transmission bitrate and to transmit the period of frames in the set of following periods of frames at the second transmission bitrate;.

In this embodiment, the the first transmission bitrate is different than the second transmission bitrate and at least one of the first transmission bitrate or the second transmission bitrate is lower than a highest bitrate that would be achievable given a current set of channel conditions.

According to embodiments, the metadata portion may be signaled within a video bitstream at a beginning of each period of frames.

In embodiments, the metadata includes a quality indicator calculated from one or more of the quality metrics consisting of PSNR, SSIM, and VMAF.

According to other aspects of some embodiments, each period of frames is represented in a plurality of bitrate versions. In these embodiments, the metadata portion may be signaled within a video bitstream at a beginning of each version of each period of frames.

According to these embodiments, a method may also include determining the current set of channel condition, determining the highest bitrate that would be achievable for the current set of channel conditions, and determining a version of the current period of frames to be transmitted and decoded according to the current set of channel conditions. In such embodiments, the analyzing of the metadata in the current period of frames is based on the version of the current period of frames to be transmitted. Similarly, in systems according to these embodiments, the processor may be configured to determine the current set of channel conditions, the highest bitrate that would be achievable for the current set of channel conditions and a version of the current period of frames to be transmitted and decoded according to the current set of channel conditions. The processor may also be configured to analyze the metadata in the current period of frames based on the version of the current period of frames to be transmitted.

Non-transitory computer readable media is also provided containing computer program code, which can be executed by a computer processor for performing any or all of the steps, operations, or processes described.

### DESCRIPTION OF THE FIGURES

FIG. 1 is a diagram illustrating a system according to one embodiment.

FIG. 2 is a flowchart illustrating a method according to one embodiment.

### DESCRIPTION OF THE INVENTION

The following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments.

The above and other needs are met by the disclosed methods, a non-transitory computer-readable storage medium storing executable code, and systems for streaming and playing back video content.

To address the problem identified above, in one embodiment, a streaming adaption algorithm in a video streaming system optimizes the buffering of periods of frames of a video presentation in order to achieve a more constant perceptual quality throughout the entire video presentation. For this, the adaption algorithm chooses to transmit some periods at a lower bitrate that the channel conditions of the channel may allow while transmitting other periods at a higher bitrate in order to optimize the bitrate and the expected perceptual quality of each version of each period over time. In one embodiment, the adaption algorithm can then optimize the overall viewing experience for the entire video presentation or stream.

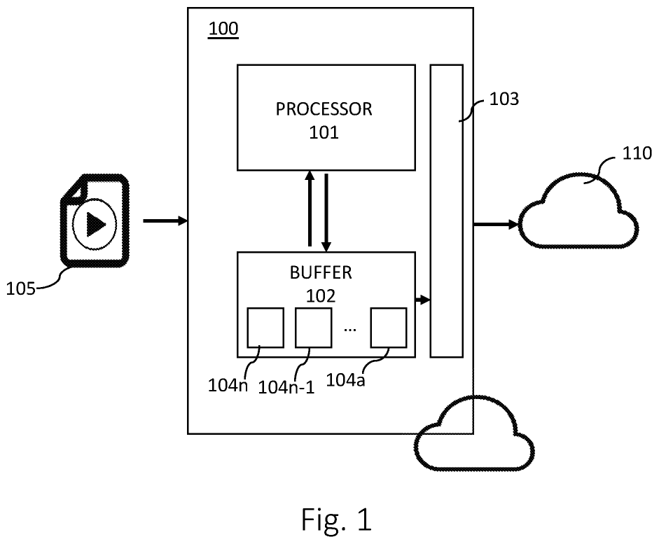

Referring to FIG. 1, a video streaming system 100 is illustrated according to one embodiment. The system 100 includes a processor_of a video presention 105. A current period of frames 104a is analyzed by the processor, inspecting a metadata portion with information descriptive of the expected visual quality of each bitrate version for the current period and within a set of following or future periods 104n-1, 104n. Each period of frames 104a-n may include multiple versions for different bitrates to be transmitted according to channel conditions. A network interface 103 transmits each selected period of frames at bitrates determined by the processor 101. The processor 101 may determine the network conditions of the channel 110, such as an Internet connection to a client device (not shown). Based on the channel conditions, the processor may determine a maximum transmission bitrate for the current channel conditions.

In order to perform the proposed adaption, in one embodiment, the adaption algorithm uses information descriptive of the expected visual quality of each bitrate version for the current period and within a set of following or future periods. These quality indicators are signaled within the video bitstream at the beginning of each version of each period. At first, the ID of the current representation as well as the length of the period in frames and the number of different representations are signaled. The quality indicator may be signaled for every representation of the current period. Finally, the quality indicators for a selected number of subsequent periods is also signaled and considered by the adaptation algorithm to achieve a more uniform presentation quality.

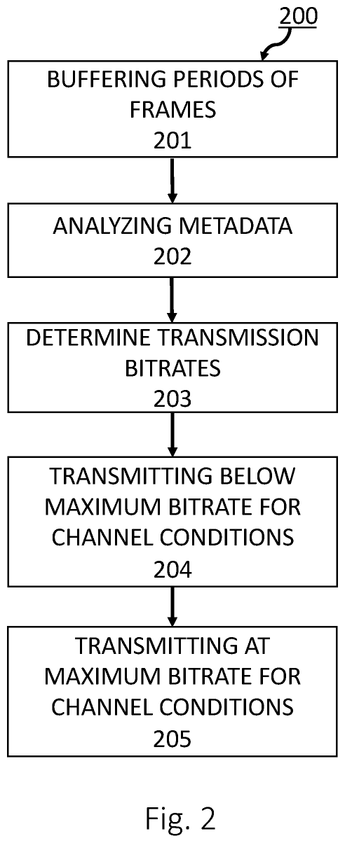

FIG. 2 provides a flow chart illustrative of a method according to embodiments. According to one embodiment, a method is provided for optimizing buffering of periods of frames of a streaming video presentation while minimizing variation in perceptual quality of the video presentation. In this embodiment, the method 200 comprises buffering 201 a plurality of periods of frames of a video presentation for transmission in a stream. Each period of frames in the plurality of periods of frames includes a metadata portion with metadata descriptive of an expected visual quality of the period of frames and a set of following periods of frames. The method further comprises analyzing 202 the metadata in a current period of frames to determine 203 a first transmission bitrate for the current period of frames and a second transmission bitrate for a period of frames in the set of following periods of frames. In this embodiment, the first transmission bitrate and the second transmission bitrate are selected to maintain a substantially uniform visual quality based on the expected visual quality.

According to this embodiment, the method also includes transmiting 204 the current period of frames at the first transmission bitrate. For example, the current period of frames may be transmitted at a bitrare that is below the maximum bitrate achievable under current channel conditions. The method also includes transmitting 205 the period of frames in the set of following periods of frames at the second transmission bitrate, which in one embodiment may be at the maximum bitrate for the current channel conditions. In one embodiment, the the first transmission bitrate is different than the second transmission bitrate and at least one of the first transmission bitrate or the second transmission bitrate is lower than a highest bitrate that would be achievable given a current set of channel conditions.

According to one embodiment, the following metadata signaling elements may be used in the bitstream:

Type

metadata_quality_indicators( sz ) {

| | |
|---|---|
| current_representation_id | f(8) |
| period_duration_frames | f(16) |
| number_quality_representations | f(8) |
| current_set_quality_indicators_present | f(1) |
| if (current_set_quality_indicators_present) { | |

for (i = 0; i < number_quality_representations;
i++)

| | |
|---|---|
| quality_indicator[i]; | f(8) |

| | |
|---|---|
| } | |
| subsequent_quality_indicators_present | f(1) |
| if (subsequent_quality_indicators_present) { | |

do {

| | |
|---|---|
| period_duration_frames | f(16) |
| for (i = 0; i < number_quality_representations; | |
| i++) | |

| | |
|---|---|
| quality_indicator[i]; | f(8) |

| | |
|---|---|
| more_quality_indicators_present | f(1) |

} while (more_quality_indicators_present)

}

}

In this embodiment,
current_representation_id: Indicates the ID of the quality representation of the current bitstream. It is a requirement that the value current_representation_id is lower than number_quality_representations. period_duration_frames: The length of the current period in frames. After the given number of frames, there should be a key-frame as well as a new metadata_quality_indicators.
number_quality_representations: Specify how many quality indicators are indicated within the metadata_quality_indicators OBU of every period. Each indicator corresponds to the quality of one version/representation of one period.
current_set_quality_indicators_present: Indicates if a set of quality indicators is signaled for the current frame period.
quality_indicator[i]: The quality indicator for the i′th representation on a scale from 0 . . . 255. A higher value indicates a higher visual quality.
Note: How to obtain the value is outside of the scope of this specification. It could be calculated from a conventional quality metric (PSNR,SSIM,VMAF), from a combination or by manual visual inspection.
subsequent_quality_indicators_present: Indicates if quality indicators of subsequent frame periods are also present in the metadata
more_quality_indicators_present: Indicates if a set of quality indicators for the next frame periods are present in the bitstream
   In different embodiments, other metadata elements and different requirements may be used without departing from the scope of this invention.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

1. A method for optimizing buffering of periods of frames of a streaming video presentation while minimizing variation in perceptual quality of the video presentation, the method comprising:
buffering a plurality of periods of frames of a video presentation for transmission in a stream, each period of frames in the plurality of periods of frames including a metadata portion with metadata descriptive of an expected visual quality of the period of frames and a set of following periods of frames;
analyzing the metadata in a current period of frames to determine a first transmission bitrate for the current period of frames and a second transmission bitrate for a period of frames in the set of following periods of frames, wherein the first transmission bitrate and the second transmission bitrate are selected to maintain a substantially uniform visual quality based on the expected visual quality;
transmiting the current period of frames at the first transmission bitrate;
transmitting the period of frames in the set of following periods of frames at the second transmission bitrate;
wherein the the first transmission bitrate is different than the second transmission bitrate and further wherein at least one of the first transmission bitrate or the second transmission bitrate is lower than a highest bitrate that would be achievable given a current set of channel conditions.

2. The method of claim 1, wherein the metadata portion is signaled within a video bitstream at a beginning of each period of frames.

3. The method of claim 1, wherein the metadata includes a quality indicator calculated from one or more of the quality metrics consisting of PSNR, SSIM, and VMAF.

4. The method of claim 1, wherein each period of frames is represented in a plurality of bitrate versions.

5. The method of claim 4, wherein the metadata portion is signaled within a video bitstream at a beginning of each version of each period of frames.

6. The method of claim 4, further comprising:
determining the current set of channel conditions;
determining the highest bitrate that would be achievable for the current set of channel conditions; and
determining a version of the current period of frames to be transmitted and decoded according to the current set of channel conditions;
wherein the analyzing the metadata in a current period of frames is based on the version of the current period of frames to be transmitted.

7. A video streaming system comprising:
a buffer, the buffer configured to buffer a plurality of periods of frames of a video presentation for transmission in a stream, each period of frames in the plurality of periods of frames including a metadata portion with metadata descriptive of an expected visual quality of the period of frames and a set of following periods of frames;
a processor configured for controlling transmissions out of the buffer, the processor configured to analyze the metadata in a current period of frames to determine a first transmission bitrate for the current period of frames and a second transmission bitrate for a period of frames in the set of following periods of frames, wherein the first transmission bitrate and the second transmission bitrate are selected to maintain a substantially uniform visual quality based on the expected visual quality; and
a network interface for streaming the video presentation, the network interface configured to transmit the current period of frames at the first transmission bitrate and to transmit the period of frames in the set of following periods of frames at the second transmission bitrate;
wherein the the first transmission bitrate is different than the second transmission bitrate and further wherein at least one of the first transmission bitrate or the second transmission bitrate is lower than a highest bitrate that would be achievable given a current set of channel conditions.

8. The system of claim 7, wherein the metadata portion is signaled within a video bitstream at a beginning of each period of frames.

9. The system of claim 7, wherein the metadata includes a quality indicator calculated from one or more of the quality metrics consisting of PSNR, SSIM, and VMAF.

10. The system of claim 7, wherein each period of frames is represented in a plurality of bitrate versions.

11. The system of claim 10, wherein the metadata portion is signaled within a video bitstream at a beginning of each version of each period of frames.

12. The system of claim 10, wherein the processor is further configured to determine the current set of channel conditions, the highest bitrate that would be achievable for the current set of channel conditions and a version of the current period of frames to be transmitted and decoded according to the current set of channel conditions; and
further wherein the processor is configured to analyze the metadata in the current period of frames based on the version of the current period of frames to be transmitted.

13. A system for streaming video comprising non-transitory computer readable media including instructions that when executed by one or more processors cause the one or more processors to implement a set of software modules comprising:
a module for buffering a plurality of periods of frames of a video presentation for transmission in a stream, each period of frames in the plurality of periods of frames including a metadata portion with metadata descriptive of an expected visual quality of the period of frames and a set of following periods of frames;
a module for analyzing the metadata in a current period of frames to determine a first transmission bitrate for the current period of frames and a second transmission bitrate for a period of frames in the set of following periods of frames, wherein the first transmission bitrate and the second transmission bitrate are selected to maintain a substantially uniform visual quality based on the expected visual quality;
a module for transmiting the current period of frames at the first transmission bitrate and for transmitting the period of frames in the set of following periods of frames at the second transmission bitrate;
wherein the the first transmission bitrate is different than the second transmission bitrate and further wherein at least one of the first transmission bitrate or the second transmission bitrate is lower than a highest bitrate that would be achievable given a current set of channel conditions.

14. The method of claim 13, wherein the metadata portion is signaled within a video bitstream at a beginning of each period of frames.

15. The method of claim 13, wherein the metadata includes a quality indicator calculated from one or more of the quality metrics consisting of PSNR, SSIM, and VMAF.

16. The method of claim 13, wherein each period of frames is represented in a plurality of bitrate versions.

17. The method of claim 16, wherein the metadata portion is signaled within a video bitstream at a beginning of each version of each period of frames.

18. The system of claim 16, further comprising:
a module for determining the current set of channel conditions;
a module for determining the highest bitrate that would be achievable for the current set of channel conditions; and
a module for determining a version of the current period of frames to be transmitted and decoded according to the current set of channel conditions;
wherein the module for analyzing the metadata in a current period of frames analyzes the metadata based on the version of the current period of frames to be transmitted.
